(19) United States
(12) Patent Application Publication
(10) Pub. No.: US 2019/0338228 A1
(43) Pub. Date: Nov. 7, 2019

(54) Spirit drink

(71) Applicant: ITALICUS LTD, London (GB)

(72) Inventor: Giuseppe Gallo, Kingston upon Thames, London Surrey (GB)

(21) Appl. No.: 16/313,026

(22) PCT Filed: Jun. 28, 2017
(86) PCT No.: PCT/IB2017/053853

§ 371 Date: Dec. 22, 2018

(30) Foreign Application Priority Data
Jun. 29, 2016 (GB) 1611239.3
Jun. 29, 2016 (IT) UA2016A004742

(51) Int. Cl. C12G 3/07

(52) U.S. Cl. CPC C12G 3/07

(57) ABSTRACT

A spirit drink that contains the following ingredients: sweetener, food-grade alcohol, an aromatic herb extract, cedar flavor, bergamot flavor, and water.

The present invention relates to an improved spirit drink and a method for its preparation.

Several types of spirit drinks are known, which are substantially defined as alcoholic drinks intended for human consumption. In particular, by normative definition, they have particular organoleptic characteristics and a minimum alcohol content of 15% vol.

In addition, generally, they are produced by distillation, maceration or the addition of flavors, or by mixing a spirit drink with other spirit drinks, ethyl alcohol of agricultural origin or certain distillates.

In particular, among the known spirit drinks which are mixed with other components to make cocktails, there are, for example:
a spirit drink made from rhubarb and marketed under the name of Aperole®,
a spirit drink obtained from the infusion of bitter herbs, aromatic plants and fruit in a mixture of alcohol and water, and marketed under the name of Campari®,
a spirit drink obtained from the infusion of Sambucus flowers and marketed under the name of St. Germaine®.

To date, however, there is no spirit drink with a bergamot flavor and taste adapted to be proposed as a drink, either alone or as an ingredient in cocktails.

US2005/0260324 describes a wine-based flavored drink and, in particular, this means, also in the light of the European legislation present in the wine industry, that the wines in the drink represent at least 50% of the weight. More in detail, the drink of US2005/0260324 comprises a first wine which is present in a percentage by weight of between 51% and 99.4% of the total flavored drink, a rectified concentrated must which is present in a percentage by weight of between 0.5% and 5% of the total flavored drink, and a mixture of natural vanilla flavor and vanilla extract in a percentage by weight not smaller than 0.1% of the total flavored drink. In particular, the object of US2005/0260324 is to flavor the drink in order to enhance only the organoleptic properties of the wine contained in such a drink.

“GNPD-Rhum Orange Sanguine Liqueur” describes a drink made of rum and, therefore, it is a brandy obtained from the distillation of molasses of sugar cane. Moreover, this drink also comprises artificial dyes (azorubine and tartrazine) and emulsifiers.

JP 2005 143424 describes an emulsifier or solubilizing agent for little alcoholic drinks, preferably with an alcohol content in a percentage by weight smaller than 5%. In particular, in order to obtain an emulsifier or solubilizing preparation, such a particular agent, which comprises the ester of polyglycolic fatty acid and an ionic emulsifier, is mixed with polyhydric alcohol, water and a water-insoluble component. Generically, JP 2005 143424 provides that the water-insoluble component may be selected from a plurality of options, which comprise coloring agents, flavoring agents, essential oils, oleosins or resinoids, waxes, fatty acids and esters, vitamins, antioxidants, saturated or unsaturated alcohols, hydrocarbons, preservatives, fungicides, plant and animal fats and oils, and the like. Finally, the emulsifier or solubilizing preparation thus obtained is used for the preparation of little alcoholic drinks.

JP 2007 295894 relates to the use of a particular sheet of wood to make a cup to be used specifically for drinking sake (also called “rice wine”), namely that typical Japanese drink obtained from a fermentation process which involves rice, water and kōji spores. In particular, such a document suggests the use of cedar wood to make said cup, and not as a flavor to use in a drink.

The object of the invention is to propose an improved spirit drink with a bergamot flavor which is adapted to be used either alone or as an ingredient in a cocktail.

Another object of the invention is to provide a spirit drink which, in the mouth, has a new improved and/or alternative taste compared to the traditional ones.

Another object of the invention is to provide a spirit drink which is alternative and improving, both in terms of composition and of organoleptic characteristics, compared to the existing ones.

Another object of the invention is to provide a bergamot-based spirit drink with an alcohol content not higher than 21% vol., and which therefore is not classifiable as a hard liquor.

Another object of the invention is to provide a spirit drink which primarily or exclusively comprises natural ingredients.

Another object of the invention is to provide a spirit drink which is affordable, thus allowing the possibility of a spreading thereof on a large scale.

Another object of the invention is to propose a process for the preparation of a spirit drink with a bergamot flavor which is simple, quick and cost-effective, as well as in line with the regulations set forth in the field.

All of these objects, taken individually or in any combination thereof, and others which will appear from the following description are achieved, according to the invention, with an improved spirit drink having the features set forth in claim 1, and with a method for its preparation having the features set forth in claim 25.

The present invention is further clarified hereinafter in some preferred embodiments thereof, given purely by way of non-limiting example.

The spirit drink according to the invention comprises: a sweetener, food-grade alcohol, aromatic herb extract, cedar flavor, bergamot flavor and water.

Advantageously, the spirit drink may also comprise plant extracts, such as gentian.

Preferably, the sweetener is of natural type. Preferably, the sweetener is cane sugar and, advantageously, it is dissolved in water to obtain a corresponding syrup. Alternatively, the sweetener may comprise rectified concentrated must of grapes.

According to a first preferred embodiment, the spirit drink according to the invention only consists of the following ingredients: natural sweetener made from sugar cane, food-grade alcohol, aromatic herb extract, cedar flavor, bergamot flavor, plant flavors and water.

Advantageously, in the improved spirit drink according to the invention, the above ingredients are used according to the following amounts (which are defined by weight with respect to 100 liters of the final drink):
about 13 liters of food-grade alcohol,
about 25 kg of cane sugar and/or concentrated grape must,
about 8 liters of aromatic herb extract,
about 0.5 liters of cedar flavor,
about 0.6 liters of bergamot flavor,
about 0.11 liters of plant flavors,
the balance of water.

According to a second preferred embodiment, the spirit drink according to the invention only consists of the following ingredients: rectified concentrated must of grapes, food-grade alcohol, aromatic herb extract, cedar flavor, bergamot flavor and water.

Advantageously, the bergamot flavor is obtained starting from natural bergamot peel. In particular, the bergamot flavor is obtained from the fruits of the Citrus bergamia plants, preferably of the “mellarosa” type or, possibly, of the “vulgaris” type (i.e. common).

Preferably, the essential oils of the bergamot flavor are obtained by scraping or slow-folding from the fruits of the Citrus bergamia plants.

In particular, the fresh peels of the fruits of the Citrus bergamia plants are grated, preferably passing through abrasive rollers which are suitably constantly cleaned with water, so as to obtain a slurry which is then suitably pressed and/or filtered in order to obtain the essential oils of the bergamot flavor. Advantageously, the essential oils thus obtained are diluted in a solution of alcohol and water and, after being suitably mixed, are refrigerated to allow the deterpenation thereof.

Suitably, the bergamot flavor is pleasant and slightly acid.

Advantageously, the cedar flavor is obtained starting from natural cedar peel, preferably Sicilian. In particular, the cedar flavor is obtained from the peel of the fruit of the Citrus medica plants.

Preferably, the essential oils of the cedar flavor are obtained by scraping or slow-folding from the fruits of the cedar plants. In particular, the fresh peels of the fruits of the Citrus medica plants are grated, preferably passing through abrasive rollers which are suitably constantly cleaned with water, so as to obtain a slurry which is then suitably pressed and/or filtered in order to obtain the essential oils of the cedar flavor. Advantageously, the essential oils thus obtained are diluted in a solution of alcohol and water and, after being suitably mixed, are refrigerated to allow the deterpenation thereof.

Suitably, the use of the slow-folding technique allows to extract the bergamot and/or cedar flavor in a natural manner, and it also allows to obtain a flavor as similar as possible to the corresponding fruit in terms of taste and scent.

Advantageously, the aromatic herb extract gives a tonic and floral taste and a bright yellow hue to the drink. Preferably, the aromatic herb extract comprises, for example, gentian, lavender, lemon balm and/or Roman chamomile.

Suitably, the cedar flavor gives a citrus taste and a lime green color hue to the drink.

Suitably, the bergamot flavor gives a sour and refreshing taste and a dull yellow color hue to the drink.

Suitably, the simultaneous presence (combination), in the drink according to the invention, of the cedar flavor and the bergamot flavor is an optimal solution/selection in order to enhance and specifically highlight the intensity of the bergamot flavor and thus give a greater persistence of both its taste and scent in the mouth.

Therefore, suitably, the drink mainly has the taste of bergamot in the mouth, which thus overcomes the cedar and the aromatic herb extract flavor, with a hint of flowers and roots.

Preferably, the sweetener is dissolved in the liquid so as to be at about 65° Bx.

Suitably, the alcohol is of natural origin and, preferably, is obtained from cereals. More in detail, the food-grade alcohol may be the so-called “Alcool Buongusto” of natural origin.

Preferably, the water used is osmotized or demineralized.

Suitably, the overall and substantially yellow color of the drink derives mainly from the use of peels of natural bergamot and natural cedar, preferably Sicilian.

Suitably, the spirit drink according to the invention has an alcohol content of about 20% vol.

The drink may be served cold at about 5-7° C. or also at room temperature of about 20° C.

Preferably, the drink is contained and preserved in a glass bottle.

Suitably, in the drink according to the invention there are no preservatives and/or artificial colors.

The process for making the spirit drink according to the invention is as follows.

Once the final quantity o be obtained has been defined, an amount of water corresponding to about 62.5 liters per 100 liters of final drink to be obtained is introduced in a first processing tank provided with stirrer.

The sweetener is then introduced into said first tank, preferably by a pump. In particular, cane sugar in an amount of about 25 kg per 100 liters of final drink to be obtained is introduced into the first tank, and thus it melts.

Simultaneously with or subsequently to the above operations, a first part of the alcohol is introduced into a second tank, preferably by a pump. Preferably, the alcohol introduced into the second tank is equal to about 3 liters per 100 liters of final drink to be obtained.

The bergamot and cedar flavors are diluted in the alcohol introduced in the second tank. Preferably, the cedar flavor is introduced into the second tank in an amount of about 0.5 liters per 100 liters of final drink to be obtained, while the bergamot flavor is introduced into the second tank in an amount of about 0.6 liters per 100 liters of final drink to be obtained. In particular, in this manner, these flavors are suitably mixed with the alcohol, thus obtaining a mixed solution of the bergamot and cedar flavors with alcohol.

Advantageously, the plant extracts may also be introduced in the second tank, preferably in amounts of about 0.11 liters per 100 liters of final drink to be obtained.

Simultaneously with or subsequently to the above operations carried out in the second tank, a second amount of alcohol is introduced into the first processing tank, preferably by a pump, and it is mixed by means of a stirrer, preferably for about one hour. Preferably, the alcohol introduced into the first tank is equal to about 9.18 liters per 100 liters of final drink to be obtained.

Thereafter, the aromatic herb extract is introduced into the first processing tank, preferably by the pump. Preferably, such an aromatic herb extract is introduced in an amount of about 8 liters per 100 liters of final drink to be obtained. It is suitably mixed, by means of a stirrer, preferably for about one hour.

Thereafter, the mixed solution, prepared in the second tank, of said flavors and alcohol is introduced into the first processing tank, preferably by a pump. The whole is suitably mixed by a stirrer.

Finally, the water or alcohol necessary to achieve/adjust the final quantity to be obtained and which was initially defined, as well as to achieve an alcohol content of about 20% vol., are introduced into the first processing tank.

Suitably, during all of the above steps, the stirrer of the tank is always active, thereby stirring the ingredients which are added in a sequence into the same tank.

Suitably, the product thus obtained is subjected to a filtration step, preferably with filtering layers of medium porosity, in order to remove any residues and make it clear.

Advantageously, according to the present invention, the fact that the bergamot and/or cedar flavors are obtained by the slow-folding technique, as well as the particular mixing order of the ingredients, allows to suitably balance the tastes and the aromatic notes of ingredients themselves so as to enhance the taste and flavor of bergamot over the others.

From the foregoing it is apparent that the spirit drink according to the invention differs from the traditional ones in that it is the only drink which at the same time is alcohol-based (but not hard liquor, since it has an alcohol content smaller than 21% vol.), is mainly made from natural ingredients and, above all, mainly has a bergamot flavor.

In particular, the spirit drink according to the invention has a new taste in the mouth, which is improving and/or in any case alternative, compared to traditional drinks as none of these is made nor with the specific combination of ingredients nor according to the corresponding specific amounts provided in the drink according to the invention.

Moreover, the drink according to the present invention is particularly advantageous in that it is adapted to be proposed either alone or as mixing ingredient for cocktails. In particular, unlike other alcoholic drinks, it has a refreshing taste and can also be consumed alone.

Suitably, the spirit drink according to the invention does not contain any wine and, in particular, does not contain wine in an amount greater than 50% of its total weight and, therefore, cannot be regarded or qualified as a wine-based flavored drink. In view of this, it differs completely from what described in US2005/0260324.

Suitably, the spirit drink according to the invention is not obtained from the distillation of fermented sugar or saccharified substances and, therefore, cannot be regarded or qualified as a brandy and, in particular, it is not a rum. In view of this, it differs completely from what described in “GNPD-Rhum Orange Sanguine Liqueur”.

1. A spirit drink, containing, for 100 liters of said spirit drink, the following amounts of the following ingredients:
25 kg of sweetener made from sugar cane;
13 liters of food-grade alcohol;
8 liters of an aromatic herb extract;
0.5 liters of cedar flavor;
0.6 liters of bergamot flavor;
0.11 liters of plant flavors; and
a balance of water,
wherein:
said cedar flavor is obtained starting from peel of a fruit of Citrus medica plants,
said bergamot flavor is obtained starting from peel of fruits of Citrus bergamia plants, and
the aromatic herb extract comprises as at least one of gentian, lavender, lemon balm or Roman chamomile.

2.-3. (canceled)

4. The spirit drink according to claim 1, wherein said bergamot flavor is obtained by scraping or slow-folding the fruits of the Citrus bergamia plants.

5. The spirit drink according to claim 1, wherein said bergamot flavor is obtained by grating fresh fruit peels of the Citrus bergamia plants so as to obtain a pulp, which is then pressed or r filtered to obtain essential oils of the bergamot flavor.

6. The spirit drink according to claim 5, wherein said essential oils of the bergamot flavor are diluted in a solution of alcohol and/or water and, after being mixed, are subjected to a deterpenation process.

7. The spirit drink according to claim 1, wherein said cedar flavor is obtained by scraping or slow-folding from the fruits of the Citrus medica plants.

8. The spirit drink according to claim 1, wherein said cedar flavor is obtained by grating fresh fruit peels of the Citrus medica plants so as to obtain a pulp, which is then pressed and/or filtered to obtain essential oils of the cedar flavor.

9. The spirit drink according to claim 8, wherein said essential oils of the cedar flavor are diluted in a solution of alcohol and/or water and, after being mixed, are subjected to a deterpenation process.

10.-11. (canceled)

12. The spirit drink according to claim 1, wherein said spirit drink has an alcohol content of about 20% vol.

13.-16. (canceled)

17. A process of making a spirit drink according to claim 1, comprising:
introducing water into a first tank provided with a stirrer;
introducing a sweetener into the first tank;
introducing a first amount of alcohol is introduced into a second tank and in the alcohol thus introduced, dissolving a bergamot flavor and a cedar flavor are dissolved, mixed to obtain a mixed solution of said bergamot and cedar flavors and the first amount of alcohol;
introducing a second amount of alcohol into the first tank containing the water and the sweetener and mixing;
introducing an aromatic herb extract into the first tank, which contains the water, the sweetener and the second amount of alcohol and mixing; and
introducing the mixed solution of said bergamot and cedar flavors and said first amount of alcohol, prepared in said second tank, into the first tank, which contains the water, the sweetener, the second amount of alcohol and the aromatic herb extract and mixing.

18. The process according to claim 17, wherein, after introducing and/or mixing the solution of said bergamot and cedar flavors and said first amount of alcohol, prepared in said second tank, inside the first tank, containing the water, the sweetener, the second amount of alcohol and the aromatic herb extract, additional water or alcohol is introduced into the first tank to achieve an alcohol content of about 20% vol.

19. (canceled)

20. The process according to claim 17, wherein an amount of the water corresponding to about 62.5 liters per 100 liters of final drink to be obtained is introduced into said first tank.

21. The process according to claim 17, wherein an amount of the sweetener equal to about 25 kg per 100 liters of the spirit drink to be obtained is introduced into said first tank.

22. The process according to claim 17, wherein the first amount of alcohol is equal to about 3 liters per 100 liters of the spirit drink to be obtained.

23. The process according to claim 17, wherein an amount of the cedar flavor equal to about 0.5 liters per 100 liters of the spirit drink to be obtained is introduced into said second processing tank.

24. The process according to claim 17, wherein an amount of the bergamot flavor equal to about 0.6 liters per 100 liters of final drink to be obtained is introduced into said second tank.

25. The process according to claim 17, wherein, together with said cedar flavor and said bergamot flavor, plant extracts, preferably in an amount equal to about 0.11 liters per 100 liters of final drink to be obtained, are introduced into said second processing tank.

26. The process according to claim 17, wherein an amount of the aromatic herb extract equal to about 8 liters per 100 liters of the spirit drink is introduced into said first tank.

27. The process according to claim 17, wherein a third amount of alcohol equal to about 9.18 liters per 100 liters of final drink to be obtained is introduced into said second processing tank.

28. The process according to claim 27, wherein, during the process, the stirrer of said first tank is always active, thereby stirring ingredients which are added in a sequence into the first tank.

29. An improved spirit drink containing, for 100 liters of said spirit drink, the following amounts of the following ingredients:
25 kg of sweetener made from sugar cane;
13 liters of food-grade alcohol;
8 liters of an aromatic herb extract;

0. 5 liters of cedar flavor;

0. 6 liters of bergamot flavor;

0. 11 liters of plant flavors; and
a balance of water,
wherein:
said cedar flavor is obtained starting from peel of a fruit of Citrus medica plants,
said bergamot flavor is obtained starting from peel of fruits of Citrus berqamia plants, and
the aromatic herb extract comprises as at least one of gentian, lavender, lemon balm or Roman chamomile,
said spirit drink being obtained by a process comprising:
introducing water into a first tank provided with a stirrer;
introducing a sweetener into the first tank;
introducing a first amount of alcohol into a second tank and in the alcohol thus introduced, dissolving a bergamot flavor and a cedar flavor are dissolved, mixed to obtain a mixed solution of said bergamot and cedar flavors and the first amount of alcohol;
introducing a second amount of alcohol into the first tank containing the water and the sweetener and mixing;
introducing an aromatic herb extract into the first tank, which contains the water, the sweetener and the second amount of alcohol and mixing; and
introducing the mixed solution of said bergamot and cedar flavors and the first amount of alcohol, prepared in said second tank, into the first tank, which contains the water, the sweetener, the second amount of alcohol and the aromatic herb extract and mixing.

30.-37. (canceled)
